(19) United States
(12) Patent Application Publication
(10) Pub. No.: US 2012/0154223 A1
(43) Pub. Date: Jun. 21, 2012

(54) SIGNAL GENERATION THROUGH USING A GROUNDING ARM AND EXCITATION STRUCTURE

(76) Inventors: Sung-Hoon Oh, Cupertino, CA (US); Joselito dela Cruz Gavilan, San Jose, CA (US)

(21) Appl. No.: 12/975,335

(22) Filed: Dec. 21, 2010

(51) Int. Cl. H01Q 13/10; H01Q 1/24; H01Q 1/48

(52) U.S. Cl. 343/702; 343/720; 343/767

(57) ABSTRACT

Disclosed is an apparatus and method to create multiple signals by utilizing the ground plane as part of the antenna. The apparatus comprises an excitation structure that includes a first segment and a second segment joined to form an angle, the first segment to generate a first signal and the second segment to generate a second signal. The apparatus also includes a ground plane that includes a slot with a perimeter, the excitation structure residing within the perimeter of the slot. Further, the apparatus also includes at least one ground arm coupled to the ground plane and formed from at least a portion of the perimeter of the slot, the at least one ground arm to generate a third signal from at least one of the first signal or the second signal.

### BACKGROUND

Antenna designs in handset and tablet devices have been proven to work over cellular second-generation wireless telephony networks (2G) and third generation wireless telephony networks (3G). These antenna designs work, despite the ever increasing volume that these antennas take up within the ever decreasing hand set and tablet form factors. With the advent of fourth generation wireless telephony networks (4G), handsets and tablet devices will have to have antenna which must be able to accommodate not only 4G, but also 2G and 3G.

### BRIEF DESCRIPTION OF THE DRAWINGS

Some embodiments of the invention are described, by way of example, with respect to the following figures:

FIG. 1 is a diagram of a system, according to an example embodiment, for wireless communication, where each device in the system can wirelessly communicate across a network using a plurality of frequencies.

FIG. 2 is a diagram of a tablet, according to an example embodiment, that includes a ground plane, in the form of a Printed Circuit Board (PCB), with at least one slot is cut into a portion of the ground plane.

FIG. 3 is a diagram of a tablet, according to an example embodiment, that includes a ground plane, in the form of a bezel, with at least one slot cut into a portion of the ground plane.

FIG. 4 is a diagram of a tablet, according to an example embodiment, that includes a ground plane with at least one slot is cut into a portion of a ground plane, and the dimensions associated therewith.

FIG. 5 is a flow chart illustrating a method, according to an example embodiment, to build an apparatus that creates multiple signals by utilizing the ground plane as part of the antenna.

FIG. 6 is a diagram of an example computer system.

### DETAILED DESCRIPTION

Illustrated is an apparatus that creates multiple signals by utilizing the ground plane as part of the antenna. These multiple signals are achieved by capacitively coupling energy from a driven antenna element to the ground plane then to create resonant slots and arms in the ground plane to re-radiate the coupled energy at the desired frequencies of interest. These desired frequencies of interest are referenced herein as signals. A signal is a radiated field. These signals may be part of any one of a number of frequency bands including second generation (2G), third generation (3G), or fourth generation (4G) frequency bands. Additionally, these signal may be used as part of a standards including a Global System for Mobile Communications (GSM), General packet radio Service (GPRS), Enhanced Data rates for GSM Evolution (EDGE), Personal Communications Service (PCS), Code Divisional Multiple Access (CDMA), Evolution-Data Optimized (EV-DO), High-Speed Downlink Packet Access (HSDPA), High-Speed Uplink Packet Access (HSUPA), Advanced Wireless Services (AWS), Long Term Evolution (LTE), Worldwide Interoperability for Microwave Access (WiMax), Institute of Electrical and Electronics Engineers (IEEE) 802.11, IEEE 802.16, IEEE 802.15, or IEEE 802.20. In some example embodiments, the ground plane is a Printed Circuit Board (PCB), or a band of metal (e.g., a bezel) associated with an apparatus. This apparatus may be implemented as part of a computer system with wireless communication link, a wireless handset, a wireless tablet device (i.e., a slate device), a wireless portable computer, or other suitable device with an antenna for wireless connectivity to a network.

In some example embodiments, at least one slot is cut into a portion of a ground plane, where the perimeter of the slot is used in combination with one or more coupled ground arms to generate additional signals. These additional signals are generated from a signal powered by an excitation structure. The coupled ground arms are formed from the ground plane and slot cut therein, and contain some type of highly conductive metal (e.g., copper, gold, silver, or platinum). In some example embodiments, this excitation structure is formed from a first and second segment joined to form a ninety-degree angle (i.e., an “L-shaped excitation structure”). In some example embodiments, the first and second segments are joined to form some other suitable angle. For the purposes of illustration only, the L-shaped excitation structure will be used to represent the excitation structure. The L-shaped excitation structure is a direct feed antenna. This L-shaped excitation structure is powered by a source. In one example implementation, one ground arm may generate a signal associated with 4G, while another ground arm may generate a signal associated with 3G. Further, a portion of the L-shaped excitation structure may, for example, generate a signal associated with 2G. Additionally, each ground arm, L-shaped excitation structure, or a portion thereof, may be used to generate a high or low band signal associated with one or more of the above referenced signals.

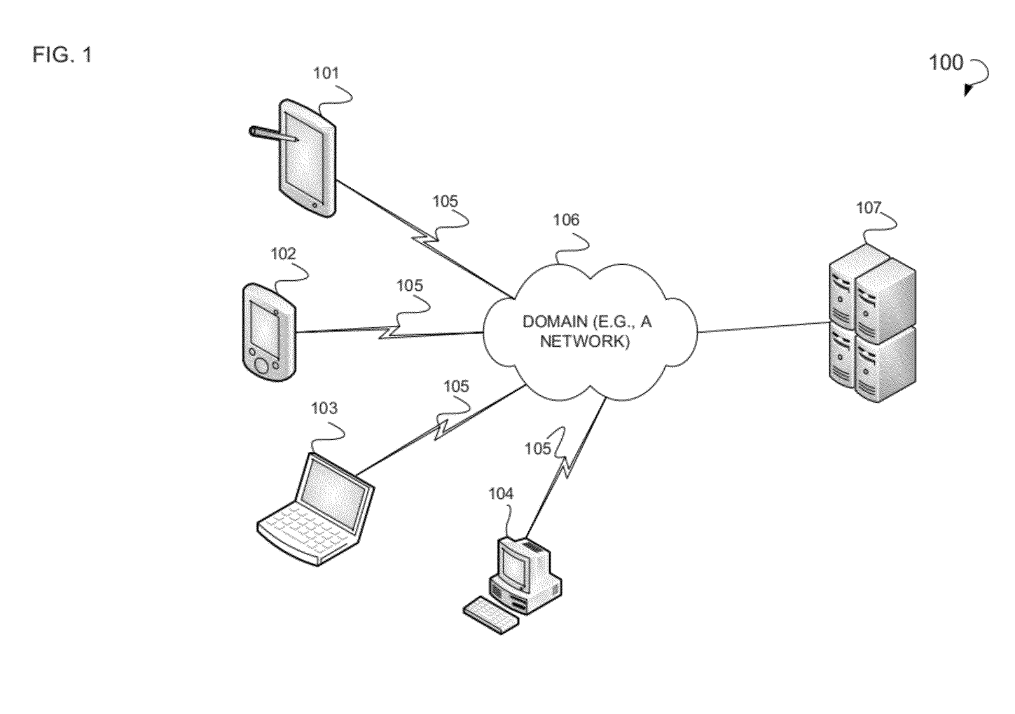

FIG. 1 is a diagram of an example system 100 for wireless communication, where each device in the system 100 can wirelessly communicate across a network using a plurality of signals. Shown is a tablet 101 wirelessly connected to a domain 106 via a wireless communication link 105. This wireless communication link 105 may utilize one or more of the above referenced frequency signals of interest and associated protocols. Also shown is a smart phone 102, portable computer 103, and computer system 104 each of which utilizing one of the wireless communication links 105. Each of the tablet 101, smart phone 102, portable computer 103, or computer system 104 may be known as a wireless apparatus. The domain 106 may be a network including a Local Area Network (LAN), Wide Area Network (WAN), an internet, or some other network and associated topology. Operatively connected to the domain 106 are one or more servers 107. Operatively connected includes a logical or physical connection.

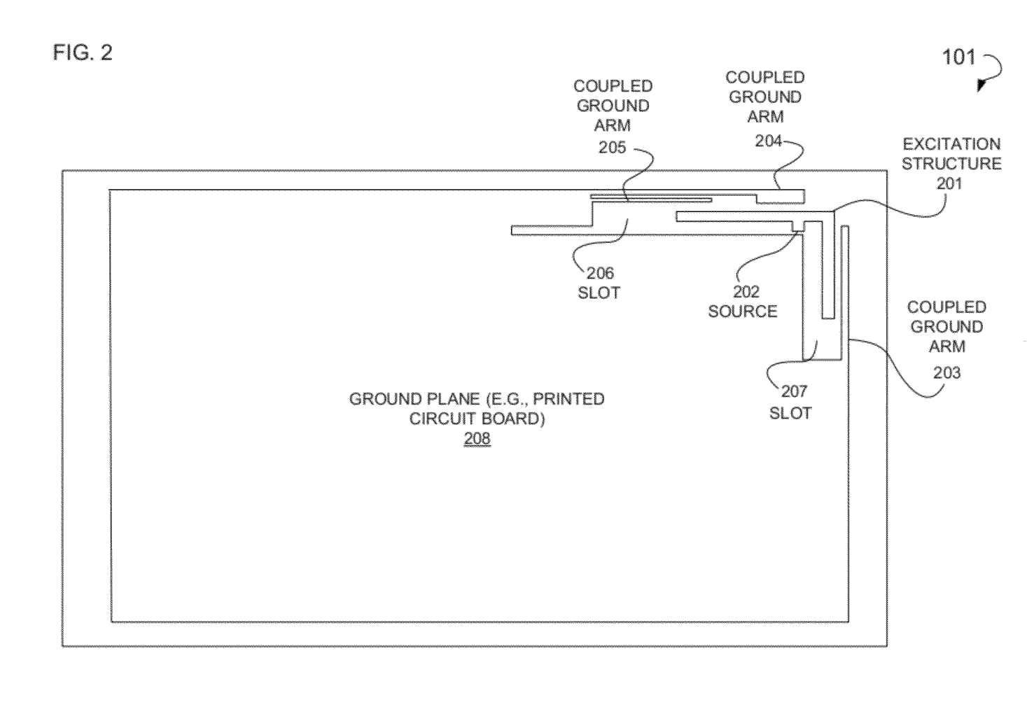

FIG. 2 is a diagram of an example tablet 101 that includes a ground plane, in the form of a Printed Circuit Board (PCB), with at least one slot is cut into a portion of the ground plane. As referenced above, the perimeter of the slot is used in combination with one or more coupled ground arms to generate additional signals. Shown is an excitation structure 201 powered by a source 202. This excitation structure 201 is an example of a direct feed antenna and the antenna elements associated therewith. As illustrated, this excitation structure 201 is L-shaped such that a portion of the excitation structure 201 may be used to generate a high-band frequency signal, while another portion may be used to generate a low band frequency signal. An example of a high band frequency signal is 1.7-2.2 Ghz. An example of a low band frequency signal is 0.7-1 Ghz. This excitation structure 201 is positioned within the slot 206 and slot 207 created from the ground plane 208. In some example embodiments, the slots 206 and 207 are cut out of the ground plane 208. Also shown are coupled ground arms 203-205 that are formed from the ground plane 208, and may be positioned parallel to the excitation structure 201. The coupled ground arms 203-205 act as additional antenna elements to generate additional signals. These additional signals are generated through a combination of the area of each coupled ground arm and the perimeter of the slot within which the excitation structure 201 is positioned. The power for the additional signals are, in effect, generated from an initial signal created by the excitation structure 201 and source associated therewith. In one example embodiment, coupled ground arms 203 and 204 generate a low band signal, while coupled ground arms 204 and 205 generate a high-band signal.

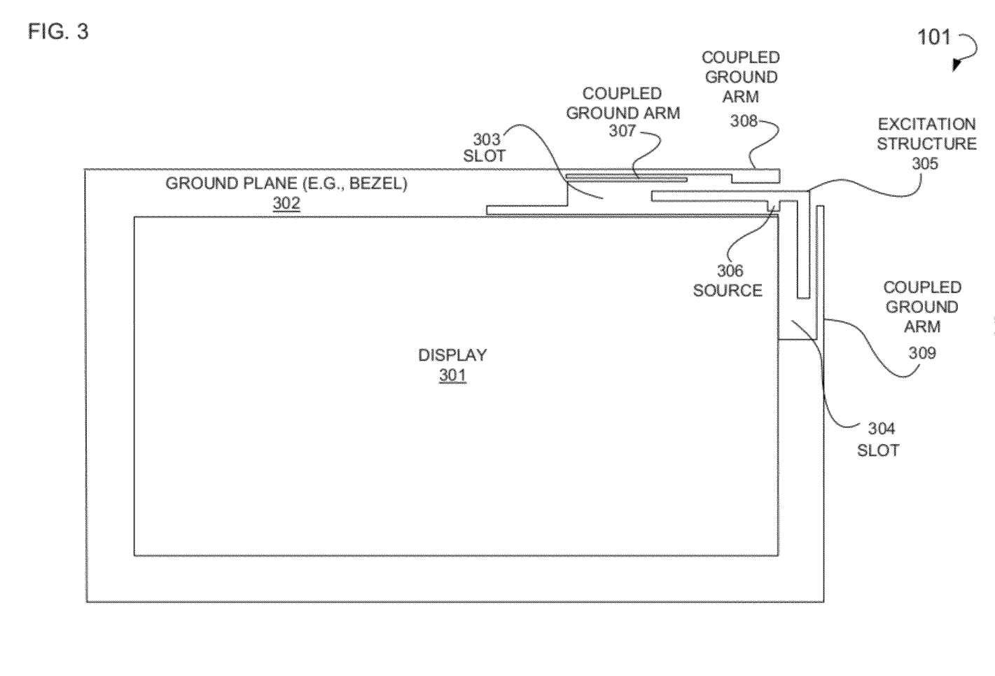

FIG. 3 is a diagram of an example tablet 101 that includes a ground plane, in the form of a bezel, with at least one slot cut into a portion of the ground plane. As referenced above, the perimeter of the slot is used in combination with one or more coupled ground arms to generate additional signals. Here, a ground plane 302, in the form of a bezel, is positioned adjacent to a display 301. This ground plane 302 may form part of the exterior surface of the tablet 101. The display may be a touch screen such as a capacitive touch screen. Slots 303 and 304 are formed from the ground plane 302. The ground plane 302 may be made of metal such as aluminum, steel, or some other suitable metal. Further, an excitation structure 305 is placed into the slots 303 and 304. The excitation structure includes a source 306. As illustrated, this excitation structure 305 is L-shaped such that a portion of the excitation structure 305 may be used to generate a high-band frequency signal, while another portion may be used to generate a low band frequency signal. An example of a high band frequency signal is 1.7-2.2 Ghz. An example of a low band frequency signal is 0.7-1 Ghz. Also shown are coupled ground arms 307-309 that are formed from the ground plane 302, and may be positioned parallel to the excitation structure 305. The coupled ground arms 307-309 act as additional antenna elements to generate additional signals. These additional signals are generated through a combination of the area of each coupled ground arm and the perimeter of the slot within which the excitation structure 305 is positioned. The power for the additional signals are, in effect, generated from an initial signal created by the excitation structure 305 and source associated therewith. In one example embodiment, coupled ground arms 308 and 309 generate a low band signal, while coupled ground arms 307 and 308 generate a high-band signal.

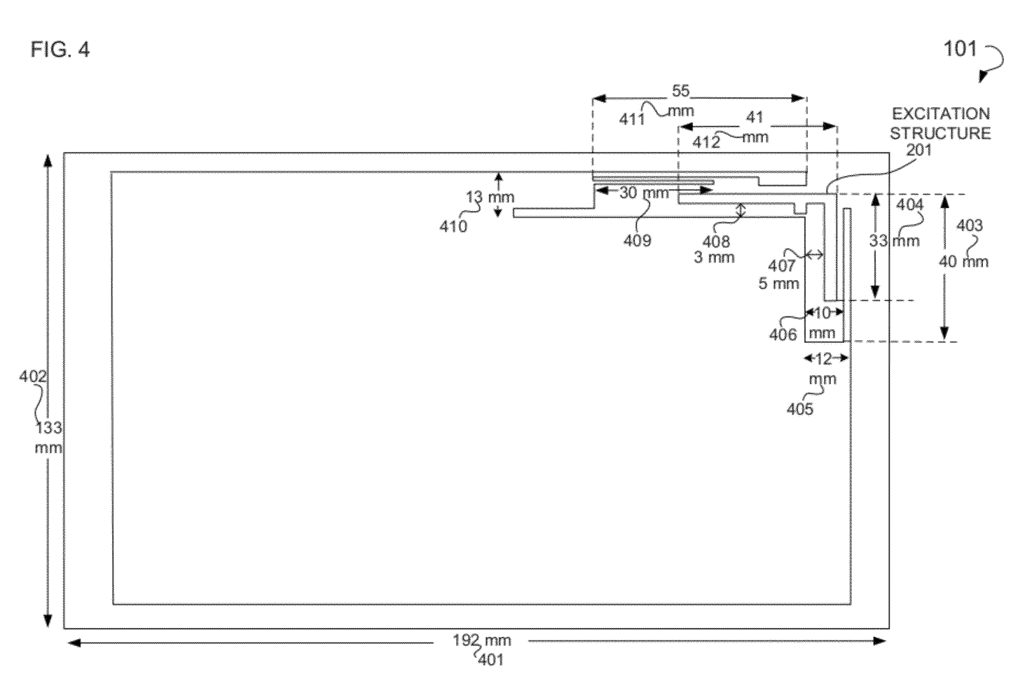

FIG. 4 is a diagram of an example tablet 101 that includes a ground plane with at least one slot is cut into a portion of a ground plane (a PCB), and the dimensions associated therewith. As illustrated at 401, the tablet 101 has a width of 192 mm. Further, as illustrated at 402, the tablet 101 has a height of 133 mm. As shown at 403, one slot is 40 mm in length. Additionally, as shown at 404, one side of the L-shaped excitation structure 201 is 33 mm in length. Further, as shown at 406, one slot is 10 mm wide, while as shown at 405 the distance from the edge of the ground plane to the inside edge of the slot is 12 mm. Moreover, as shown at 407, the distance between the inside edge of the slot and the excitation structure 201 is 5 mm. The distance between the inside edge of the slot and the other side of the L-shaped excitation structure 201 may be 3 mm, as shown at 408. As shown at 412, the other side of the L-shaped excitation structure may be 41 mm in length. Shown at 409, is a ground coupling arm that is 30 mm in length. Another ground coupling arm, as shown at 411, may be 55 mm in length. Further, as illustrated as 410, the distance between the interior edge of the slot and the PCB may be 13 mm. The optimum slot area to be used in combination with an L-shaped excitation structure 201 to generate one or more signals can be determined through an experimental method such as trial and error so as to tune the L-shaped excitation structure 201 and slot area to these one or more signals.

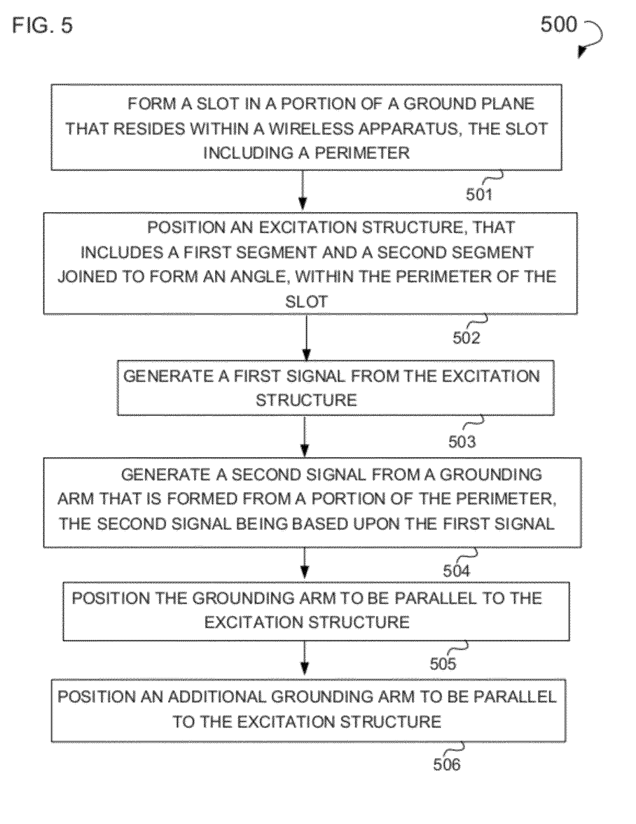

FIG. 5 is a flow chart illustrating an example method to build an apparatus that creates multiple signals by utilizing the ground plane as part of the antenna. The method may be used to build the antenna assembly shown in FIG. 2. Operation 501 is executed to form a slot in a portion of a ground plane that resides within a wireless apparatus, the slot including a perimeter. Operation 502 is executed to position an excitation structure, that includes a first segment and a second segment joined to form an angle, within the perimeter of the slot. Operation 503 is executed to generate a first signal from the excitation structure. Operation 504 is executed to generate a second signal from a grounding arm that is formed from a portion of the perimeter, the second signal being based upon the first signal. In some example embodiments, the excitation structure is a direct-feed antenna. Operation 505 is executed to position the grounding arm to be parallel to the excitation structure. Operation 506 is executed to position an additional grounding arm to be parallel to the excitation structure. In some example embodiments, the signal is used in at least one of the following standards a Global System for Mobile Communications (GSM), General packet radio Service (GPRS), Enhanced Data rates for GSM Evolution (EDGE), Personal Communications Service (PCS), Code Divisional Multiple Access (CDMA), Evolution-Data Optimized (EV-DO), High-Speed Downlink Packet Access (HSDPA), High-Speed Uplink Packet Access (HSUPA), Advanced Wireless Services (AWS), Long Term Evolution (LTE), Worldwide Interoperability for Microwave Access (WiMax), Institute of Electrical and Electronics Engineers (IEEE) 802.11, IEEE 802.16, or IEEE 802.20.

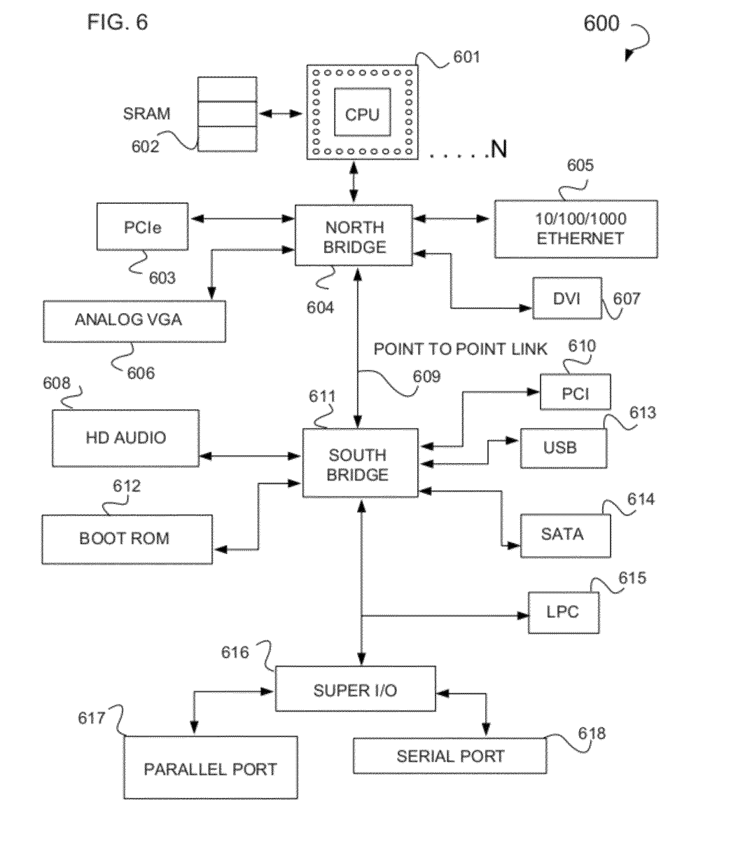

FIG. 6 is a diagram of an example computer system 600. This computer system 600 may be implemented in conjunction with the tablet 101, smart phone 102, portable computer 103, or computer system 104. Shown is a CPU 601. In some example embodiments, a plurality of CPU 601 may be implemented on the computer system 600 in the form of a plurality of core (e.g., a multi-core computer system), or in some other suitable configuration. Some example CPUs include the x86 series CPU. Operatively connected to the CPU 601 is Static Random Access Memory (SRAM) 602. Operatively connected includes a physical or logical connection such as, for example, a point to point connection, an optical connection, a bus connection or some other suitable connection. A North Bridge 604 is shown, also known as a Memory Controller Hub (MCH), or an Integrated Memory Controller (IMC), that handles communication between the CPU and PCIe, Dynamic Random Access Memory (DRAM), and the South Bridge. An ethernet port 605 is shown that is operatively connected to the North Bridge 604. A Digital Visual Interface (DVI) port 607 is shown that is operatively connected to the North Bridge 604. Additionally, an analog Video Graphics Array (VGA) port 606 is shown that is operatively connected to the North Bridge 604. Connecting the North Bridge 604 and the South Bridge 611 is a point to point link 609. In some example embodiments, the point to point link 609 is replaced with one of the above referenced physical or logical connections. A South Bridge 611, also known as an I/O Controller Hub (ICH) or a Platform Controller Hub (PCH), is also illustrated. A PCIe port 603 is shown that provides a computer expansion port for connection to graphics cards and associated GPUs. Operatively connected to the South Bridge 611 are a High Definition (HD) audio port 608, boot ROM port 612, PCI port 610, Universal Serial Bus (USB) port 613, a port for a Serial Advanced Technology Attachment (SATA) 614, and a port for a Low Pin Count (LPC) bus 615. Operatively connected to the South Bridge 611 is a Super Input/Output (I/O) controller 616 to provide an interface for low-bandwidth devices (e.g., keyboard, mouse, serial ports, parallel ports, disk controllers). Operatively connected to the Super I/O controller 616 is a parallel port 617, and a serial port 618.

The SATA port 614 may interface with a persistent storage medium (e.g., an optical storage devices, or magnetic storage device) that includes a machine-readable medium on which is stored one or more sets of instructions and data structures (e.g., software) embodying or utilized by any one or more of the methodologies or functions illustrated herein. The software may also reside, completely or at least partially, within the SRAM 602 and/or within the CPU 601 during execution thereof by the computer system 600. The instructions may further be transmitted or received over the 10/100/1000 ethernet port 605, USB port 613 or some other suitable port illustrated herein.

In some example embodiments, a removable physical storage medium is shown to be a single medium, and the term “machine-readable medium” should be taken to include a single medium or multiple medium (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any of the one or more of the methodologies illustrated herein. The term “machine-readable medium” shall accordingly be taken to include, but not be limited to, solid-state memories, optical and magnetic medium, and carrier wave signals.

In some example embodiments, the methods illustrated herein are implemented as one or more computer-readable or computer-usable storage media or mediums. The storage media include different forms of memory including semiconductor memory devices such as DRAM, or SRAM, Erasable and Programmable Read-Only Memories (EPROMs), Electrically Erasable and Programmable Read-Only Memories (EEPROMs) and flash memories; magnetic disks such as fixed, floppy and removable disks; other magnetic media including tape; and optical media such as Compact Disks (CDs) or Digital Versatile Disks (DVDs). Note that the instructions of the software discussed above can be provided on one computer-readable or computer-usable storage medium, or alternatively, can be provided on multiple computer-readable or computer-usable storage media distributed in a large system having possibly plural nodes. Such computer-readable or computer-usable storage medium or media is (are) considered to be part of an article (or article of manufacture). An article or article of manufacture can refer to any manufactured single component or multiple components.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the “true” spirit and scope of the invention.

What is claimed is:

1. An apparatus comprising:
an excitation structure that includes a first segment and a second segment joined to form an angle, the first segment to generate a first signal and the second segment to generate a second signal;
a ground plane that includes a slot with a perimeter, the excitation structure residing within the perimeter of the slot; and
at least one ground arm coupled to the ground plane and formed from at least a portion of the perimeter of the slot, the at least one ground arm to generate a third signal from at least one of the first signal or the second signal.

2. The apparatus of claim 1, wherein the apparatus includes at least one of a wireless computer system, a wireless tablet, or a wireless hand set.

3. The apparatus of claim 1, wherein the ground plane is at least one of a Printed Circuit Board (PCB), or a bezel.

4. The apparatus of claim 1, wherein the angle is ninety-degree angle.

5. The apparatus of claim 1, wherein the at least one ground arm is parallel to the excitation structure.

6. The apparatus of claim 1, wherein the signal is used in at least one of the following standards a Global System for Mobile Communications (GSM), General packet radio Service (GPRS), Enhanced Data rates for GSM Evolution (EDGE), Personal Communications Service (PCS), Code Divisional Multiple Access (CDMA), Evolution-Data Optimized (EV-DO), High-Speed Downlink Packet Access (HSDPA), High-Speed Uplink Packet Access (HSUPA), Advanced Wireless Services (AWS), Long Term Evolution (LTE), Worldwide Interoperability for Microwave Access (WiMax), Institute of Electrical and Electronics Engineers (IEEE) 802.11, IEEE 802.16, or IEEE 802.20.

7. A method comprising:
forming a slot in a portion of a ground plane that resides within a wireless apparatus, the slot including a perimeter;
positioning an excitation structure, that includes a first segment and a second segment joined to form an angle, within the perimeter of the slot;
generating a first signal from the excitation structure; and
generating a second signal from a grounding arm that is formed from a portion of the perimeter, the second signal being based upon the first signal.

8. The method of claim 7, wherein the excitation structure is a direct-feed antenna.

9. The method of claim 7, further comprising positioning the grounding arm to be parallel to the excitation structure.

10. The method of claim 7, further comprising positioning an additional grounding arm to be parallel to the excitation structure.

11. The method of claim 7, wherein the signal is used in at least one of the following standards a Global System for Mobile Communications (GSM), General packet radio Service (GPRS), Enhanced Data rates for GSM Evolution (EDGE), Personal Communications Service (PCS), Code Divisional Multiple Access (CDMA), Evolution-Data Optimized (EV-DO), High-Speed Downlink Packet Access (HSDPA), High-Speed Uplink Packet Access (HSUPA), Advanced Wireless Services (AWS), Long Term Evolution (LTE), Worldwide Interoperability for Microwave Access (WiMax), Institute of Electrical and Electronics Engineers (IEEE) 802.11, IEEE 802.16, or IEEE 802.20.

12. A computer system comprising:
a touch-sensitive screen for receiving user input;
a processor to convert the user input into an electrical signal;
an excitation structure that includes a first segment and a second segment joined to form an angle, the first segment to generate a first signal from the electrical signal;
a bezel with a slot that includes a perimeter, the excitation structure residing within the perimeter of the slot; and
at least one ground arm coupled to the bezel, and formed from at least a portion of the perimeter of the slot, the at least one ground arm to generate a second signal from the first signal.

13. The computer system of claim 12, wherein the ground arm is an antenna element.

14. The computer system of claim 12, wherein the angle is a ninety-degree angle.

15. The computer system of claim 12, wherein the bezel forms at least part of an exterior surface of the computer system.
